(19) United States
(12) Patent Application Publication
(10) Pub. No.: US 2013/0297231 A1
(43) Pub. Date: Nov. 7, 2013

(54) Automated Method of Ultrasonically Scanning Cutters While on the Bit for Crack Detection

(71) Applicants: Travis E. Puzz, Houston, TX (US); Dan E. Scott, Montgomery, TX (US)

(72) Inventors: Travis E. Puzz, Houston, TX (US); Dan E. Scott, Montgomery, TX (US)

(73) Assignee: BAKER HUGHES INCORPORATED, HOUSTON, TX (US)

(21) Appl. No.: 13/464,614

(22) Filed: May 4, 2012

(51) Int. Cl. G06F 19/00; G01N 29/04

(52) U.S. Cl. 702/39; 73/627

(57) ABSTRACT

An apparatus and method for determining a condition of a cutter coupled to a drill bit is disclosed. A support is configured to dispose the drill bit and the cutter at a selected location. A positioning device positions an ultrasonic transducer relative to the drill bit. The ultrasonic transducer and generates an ultrasonic pulse. A reflection of the ultrasonic pulse at a reflective surface of the cutter is obtained at the ultrasonic transducer. A processor receives the reflected pulse and forms an image of the reflective surface of the cutter using the reflected ultrasonic pulse while the cutter is coupled to the drill bit.

### BACKGROUND OF THE DISCLOSURE

1. Field of the Disclosure

The present disclosure relates generally to non-destructive testing methods and apparatuses and in particular to ultrasonic testing of drill bit cutters.

2. Description of the Related Art

Drill bits used in drilling geological formations are typically worn down with use. Therefore, after a selected time of use, drill bits and in particular cutter elements of the drill bits are generally inspected for evidence of wear, such as cracks, chips, etc. in order to determine their viability for continued use. Typical methods of inspecting the cutters require disassembling the drill bit which leaves the drill bit susceptible to damage during testing. Therefore, there is a need for methods for inspecting a drill bit that maintains the structural integrity of the drill bit for later drilling. The present disclosure provides an inspection process using ultrasonic imaging methods that provides a reusable drill bit after the inspection process is complete.

### SUMMARY

In one aspect, the present disclosure provides a method of determining a condition of a cutter coupled to a drill bit, including: disposing the drill bit and the cutter at a selected location; positioning an ultrasonic transducer relative to the cutter; activating the ultrasonic transducer to generate an ultrasonic pulse; obtaining a reflection of the ultrasonic pulse from a reflective surface of the cutter; and forming an image of the cutter while coupled to the drill bit using the reflected ultrasonic pulse.

In another aspect, the present disclosure provides an apparatus for determining a condition of a cutter on a drill bit, including: a support configured to dispose the drill bit and the cutter at a selected location; an ultrasonic transducer configured to generate an ultrasonic pulse and obtain a reflection of the generated ultrasonic pulse from a reflective surface of the cutter; a positioning device configured to position the ultrasonic transducer relative to the cutter; and a processor configured to form an image of the reflective surface of the cutter using the reflected ultrasonic pulse while the cutter is coupled to the drill bit.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description, taken in conjunction with the accompanying drawings, in which like elements have been given like numerals and wherein:

FIG. 1 shows an isometric view of an exemplary drill bit that is generally tested using the exemplary methods and apparatus disclosed herein;

FIG. 2 shows a profile view of an exemplary cutter of the exemplary drill bit of FIG. 1;

FIG. 3 shows an apparatus in an exemplary embodiment of the present disclosure for inspecting the exemplary cutter while on the drill bit;

FIG. 4 shows details of an exemplary positioning assembly for positioning the ultrasonic transducer relative to the drill bit;

FIG. 5 shows an image of a surface of a cutter obtained using the exemplary ultrasonic imaging methods of the present disclosure; and

FIG. 6 shows an image of the interface of the cutter of FIG. 5 obtained using the exemplary ultrasonic imaging methods of the present disclosure.

### DETAILED DESCRIPTION OF THE DISCLOSURE

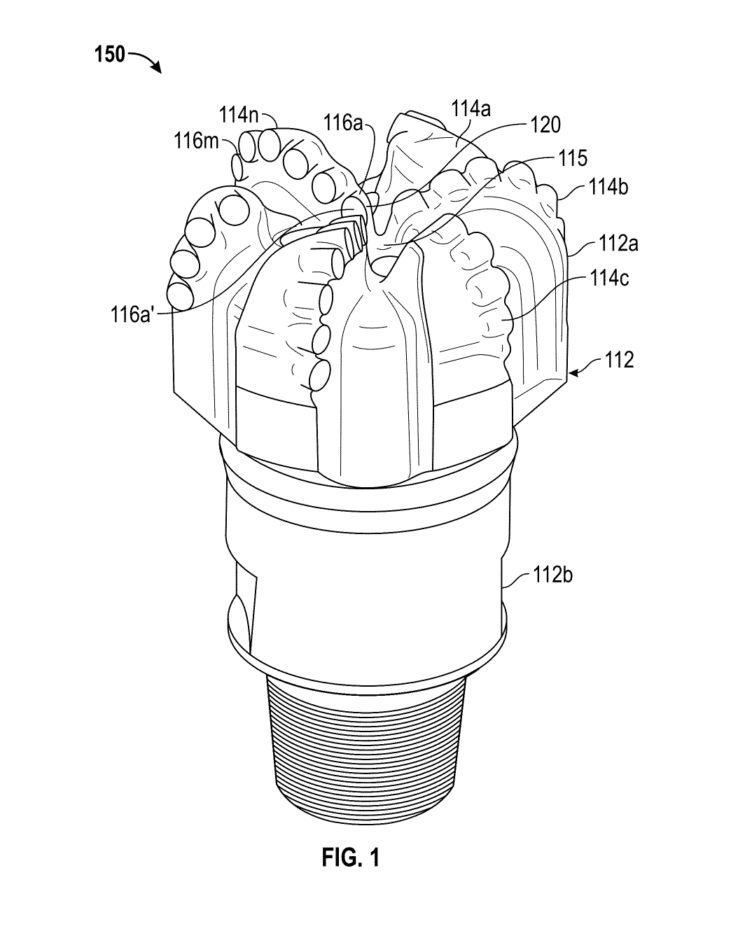

FIG. 1 shows an isometric view of an exemplary drill bit that is generally tested using the exemplary methods and apparatus disclosed herein. In one embodiment, the exemplary drill bit includes a polycrystalline diamond compact (PDC) drill bit. The drill bit 150 is shown to include a drill bit body 112 comprising a cone 112a and a shank 112b. The cone includes a number of blade profiles (or profiles) 114a, 114b, . . . , 114n. A number of cutters are placed along each profile. For example, profile 114a is shown to contain cutters 116a-116m. The profiles are shown to terminate at the bottom of the drill bit 150. Each cutter has a cutting surface or cutting element, such as element 116a′ of cutter 116a, that engages the rock formation when the drill bit 150 is rotated during drilling of the wellbore. Each cutter 116a-116m has a back rake angle and a side rake angle that defines the cut made by that cutter into the formation.

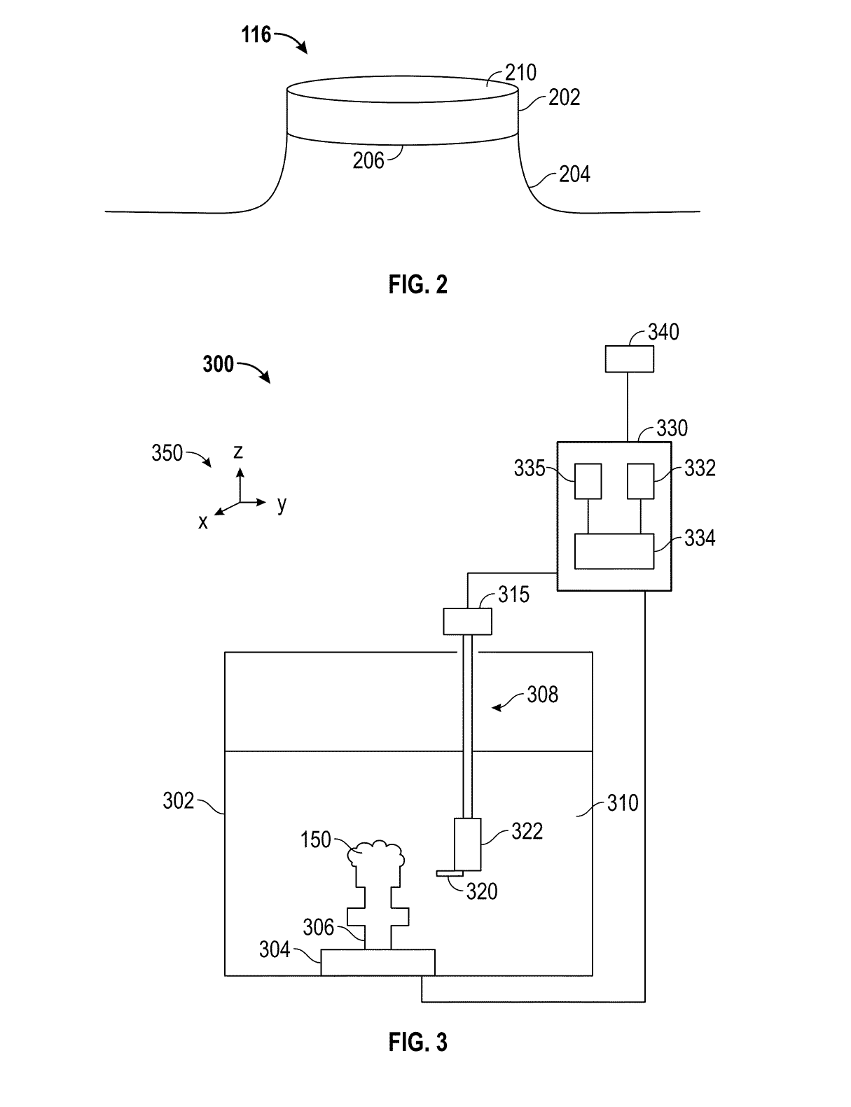

FIG. 2 shows a profile view of an exemplary cutter 116 of the exemplary drill bit of FIG. 1. The exemplary cutter is a polycrystalline diamond compact (PDC) cutter that includes a diamond table 202 coupled to a carbide substrate 204 of the drill bit at an PDC-carbide interface 206. The diamond table 202 may be coupled to the carbide substrate 204 using various methods, such as by cementing, braising, etc. In general, the carbide substrate 204 is used to support the diamond table 202 for cutting during drilling operations as well as to assist in the manufacturing of the diamond table 202. A cutting surface 210 of the diamond table 202 is used to cut and/or shear a rock formation during drilling operations.

FIG. 3 shows an apparatus 300 in an exemplary embodiment of the present disclosure for inspecting the exemplary cutter 116 while on the drill bit 150. The exemplary apparatus 300 includes a tank 302, a drill bit positioning device 304 for positioning the drill bit 150 in the tank, a support 306 mechanically coupled to the drill bit positioning device 304 for supporting the drill bit in the tank 302 at a selected testing location, and an imaging device 308 configured to obtain an ultrasonic image of the drill bit at the selected testing location. The drill bit positioning device 304 can be moved in the x-y plane as indicated by the coordinate system 350. Additionally, the drill bit positioning device 304 is configured to provide a rotation of 360 degrees in the x-y plane, e.g. around the z-axis. In an exemplary embodiment, the tank 302 is filled with a fluid 310 that acts as an acoustic coupler to propagate ultrasonic waves or pulses. An exemplary acoustic coupler is water.

The imaging device 308 includes an ultrasonic transducer 320 coupled to a positioning assembly 322 suspended from support 315. In one aspect, the support 315 may be used to position the ultrasonic transducer with respect to the drill bit 315. The imaging device 306 may be coupled to control unit 330 to provide electrical signals and data to the control unit. In one aspect, the control unit processes various data and signals obtained at ultrasonic transducer 320 to form an image. In other aspects, the control unit 300 may control a position and orientation of the ultrasonic transducer 320 and control various operating parameters of the transducer, such as focal length, frequency, etc. In various aspects, control unit 330 includes at least one memory 332 having various programs and data stored therein, a computer or processor 334 accessible to the memory and configured to access one or more of the programs and/or data stored therein to perform various methods disclosed herein, and a recording medium 336 for recording and storing the obtained signals and/or image and various results obtained using the methods disclosed herein. Exemplary methods performed by the processor include positioning the ultrasonic transducer, operating the ultrasonic transducer in transmitter and receiver modes, forming an image from signals related to a reflected ultrasonic pulse, storing at least one of the signals related to the reflected ultrasonic pulse and the formed image and determining a course of actions with respect to a cutter or drill bit, such as whether to replace the cutter or drill bit. The control unit 330 may further provide output, such as the received signal, the formed image and/or the recommended course of action to various devices, such as a display 340. In one embodiment, the processor 334 executes a program for studying the obtained images that determines a recommended course of action with respect to a cutter and/or drill bit, such as to reuse or replace the drill bit. The processor may determine from the images whether a particular cutter is to be replaced or may be reused. This determination may be based on various factors, including a location of a crack or defect and/or an extent of a crack or defect. In various embodiments, the processor executes an artificial intelligence program, such as a neural network, to determine a state of a cutter or drill bit and recommend a course of action with respect to a drill bit and/or its cutters. The artificial intelligence program may compare the condition of the cutter, i.e. crack length, crack size, crack location, number of defects, etc. to various threshold levels to arrive at the recommended course of action. In general, an operator may review the recommended course of action and accept or override the recommendation.

The ultrasonic transducer 320 may be operable in at least a transmitter mode and a receiver mode. In the transmitter mode, the ultrasonic transducer is configured to generate at least one ultrasonic pulse. In the receiver mode, the ultrasonic transducer is configured to receive an ultrasonic signal and send electronic signals related to the received ultrasonic signal to the control unit 330 for processing. In one embodiment, the ultrasonic transducer may include a single piezoelectric element. In another aspect the ultrasonic transducer may be a phased array of piezoelectric elements. The piezoelectric elements of the phased array can be activated in any sequence, thereby providing the ability to generate a selected wave front as well as to direct the generated wave front along a given direction and/or at a selected location. In another embodiment, the ultrasonic transducer 320 may include a first transducer having a first focal length and a second transducer having a second focal length. The first transducer and the second transducer can be alternately set into a selected position relative and orientation to the cutter in order to generate ultrasonic pulses and obtain reflected ultrasonic pulses.

The ultrasonic transducer may generate an ultrasonic pulse in the transmitter mode. In an exemplary embodiment, the generated ultrasonic pulse has a frequency of about 50 MHz, although other ultrasonic frequencies can be used in various embodiments. The exemplary transducer has an aperture of about 0.125 inches in diameter. The focal length of the ultrasonic transducer can be a selected length, and is generally either 0.5 inches or 1 inch in various embodiments. Alternatively, the focal length of the ultrasonic transducer may be a variable quantity that covers a range of distances. In various aspects, the ultrasonic transducer 320 is configured to generate the ultrasonic pulse for reflection at a selected focal plane. In one aspect, a focal plane of the ultrasonic pulse is selected to be located at the cutting surface 210 of the diamond table 202. In another embodiment, the focal plane is selected to be located at the interface 206 between the diamond table and the carbide substrate.

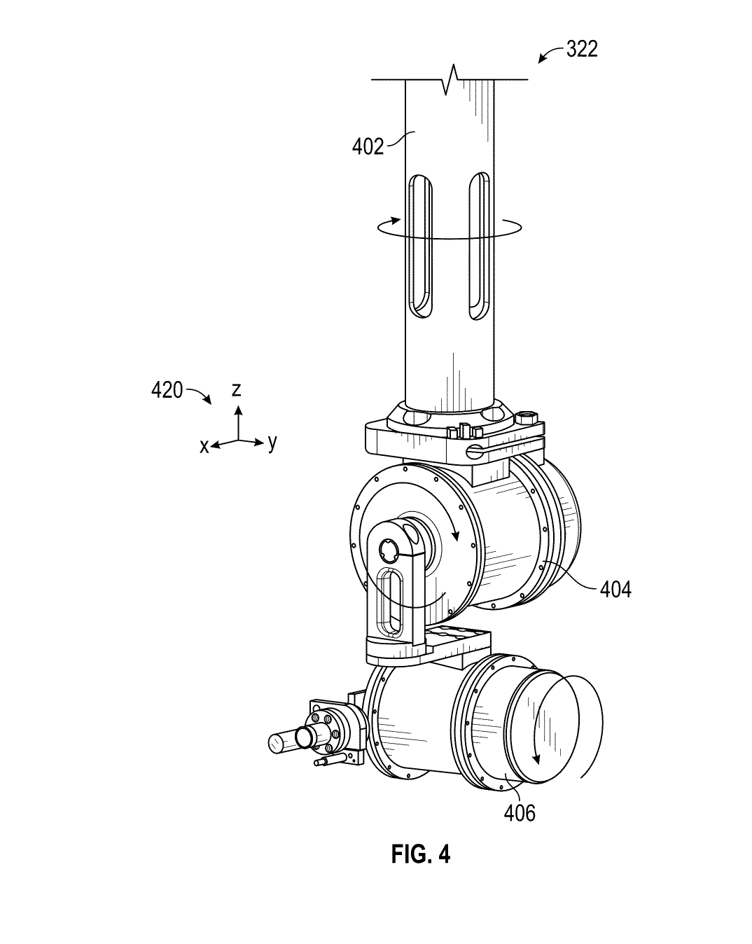

FIG. 4 shows details of an exemplary positioning assembly 322 of the imaging device 308 for positioning the ultrasonic transducer 320 relative to the drill bit. The exemplary positioning assembly 308 includes a dual-gimbal assembly. Member 402 is suspended from support 315, which may be located at a top of the tank 302 or outside of the tank, for example. Support 315 provides movement of the member 402 in any direction, i.e., x-, y- and z-directions as indicated by coordinate system 420 as well as provides rotation of the member 402 around the z-axis. First gimbal 404 is suspended from the member 402 and may be used to provide a rotation about the x-axis. Second gimbal 406 is suspended from first gimbal 404 and may be used to provide a rotation about the y-axis. The ultrasonic transducer 320 is coupled to the second gimbal 406. Thus, the exemplary positioning assembly 322 can be used to control to place the transducer at a select location by controlling its x, y and z coordinates. Additionally, the positioning assembly 322 can be used to control an orientation of the transducer 320 by rotating the member 402, first gimbal 404 and second gimbal 406 about their respective rotational axes. Thus, the positioning assembly 322 may be used to place the ultrasonic transducer 320 at a selected location and selected orientation with respect to the drill bit 150.

Returning to FIG. 3, control unit 330 is coupled to imaging device 308 and controls the position of the ultrasonic transducer 320. In one aspect, the control unit 330 positions the transducer 320 by using a computer model of the drill bit that may be programmed or stored in the memory 332 or provided to the processor 334 from a separate memory location. In various embodiments, the model of the drill bit may provide dimensions of the drill bit and include the locations and orientations of various objects at the drill bit, such as the cutters 116 as well as their back rake or side rake angles. In an exemplary embodiment, the location and orientation of the drill bit at the selected testing location is sent to processor 334. The processor 334 may compare the model with the orientation and location of the drill bit in order to determine a position and orientation of the ultrasonic transducer with respect to the drill bit. In another aspect, the control unit 330 may use a detection system to determine position and orientation of a selected cutter and which can be used to select a position and orientation of the ultrasonic transducer. In one embodiment, the detection system is conveyed on the positioning assembly 322. In one embodiment, the detection system includes a laser that scans an object in the laser path to identify an object or contour of the drill bit, its position and orientation, thereby allowing the transducer to be aligned relative the selected object.

In an exemplary operation of the scanning apparatus, the drill bit 150 is placed in the tank 302 so as to be submerged in fluid 308. The drill bit 150 is placed at a selected testing location and at a selected orientation. Testing location and orientation may be sent to control unit 330. The ultrasonic transducer 320 is placed at a selected transducer location and orientation with respect to the drill bit based on the selected testing location and orientation of the drill bit 150. The ultrasonic transducer 320 is operated in a transmitter mode to generate an ultrasonic pulse which is reflected at a reflective surface of the drill bit, such as cutting face 210 or interface 206. The reflected ultrasonic pulse is received at the ultrasonic transducer operating in a receiver mode. Signals related to the received pulse are generated at the ultrasonic transducer and sent to the control unit 330 for processing to form an image of the reflective surface. In various embodiments, a focal line of the ultrasonic transducer 320 can be moved in a raster pattern to form the image at the control unit 330.

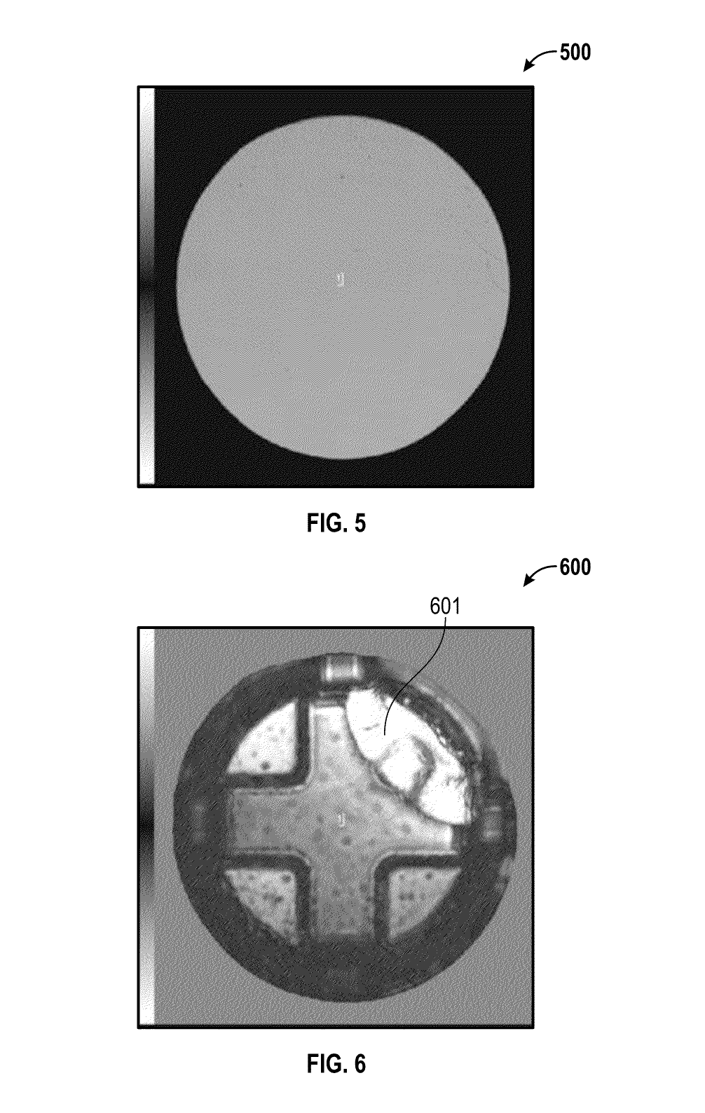

FIG. 5 shows an image 500 of a surface of a cutter obtained using the exemplary ultrasonic imaging methods of the present disclosure. The surface image is substantially free from defects. FIG. 6 shows an image 600 of the interface of the cutter of FIG. 5 obtained using the exemplary ultrasonic imaging methods of the present disclosure. The image shows damage 601 to the interface at the top-right edge of the cutter interface. Thus, while no defects are visible in the surface image 500, the interface image 600 reveals sub-surface cracks that are identified using the methods of the present disclosure. FIGS. 5 and 6 may be thus used to determine the viability of the drill bit and cutters for further use. Drill bits that are determined suitable for further use can be immediately used in drilling operations.

Therefore, in one aspect, the present disclosure provides a method of determining a condition of a cutter coupled to a drill bit, including: disposing the drill bit and the cutter at a selected location; positioning an ultrasonic transducer relative to the cutter; activating the ultrasonic transducer to generate an ultrasonic pulse; obtaining a reflection of the ultrasonic pulse from a reflective surface of the cutter; and forming an image of the cutter while coupled to the drill bit using the reflected ultrasonic pulse. In one embodiment, the drill bit is submerged in an acoustically coupling fluid. The acoustic transducer may be positioned relative to the cutter further comprises using at least one of: (i) a model of the drill bit; and (ii) a detection system for locating the cutter at the selected location. Positioning the ultrasonic transducer relative to the cutter further includes controlling a position and orientation of the ultrasonic transducer. The ultrasonic pulse may be generated by activating the transducer at a frequency selected to obtain the reflected ultrasonic pulse from at least one of: (i) a cutting surface of the cutter; and (ii) an interface of the cutter and a substrate coupling the cutter to the drill bit. In various embodiments, the use of the at least one ultrasonic transducer includes using at least one of: (i) a single ultrasonic transducer having an adjustable focal length; and (ii) a first ultrasonic transducer having a first focal length and a second ultrasonic transducer having a second focal length. The ultrasonic transducer may be a single transducer or a phased array transducer. In various embodiments, the ultrasonic transducer is activated to perform a raster scan. The formed image may be scanned by an artificial intelligence program which generates a recommended course of action with respect to the drill bit.

In another aspect, the present disclosure provides an apparatus for determining a condition of a cutter on a drill bit, including: a support configured to dispose the drill bit and the cutter at a selected location; an ultrasonic transducer configured to generate an ultrasonic pulse and obtain a reflection of the generated ultrasonic pulse from a reflective surface of the cutter; a positioning device configured to position the ultrasonic transducer relative to the cutter; and a processor configured to form an image of the reflective surface of the cutter using the reflected ultrasonic pulse while the cutter is coupled to the drill bit. The tank may contain an acoustically coupling fluid, wherein the selected location of the drill bit is within the acoustically coupling fluid. The processor may be used to position the acoustic transducer relative to the cutter further using at least one of: (i) a model of the drill bit; and (ii) a detection system for locating the cutter at the selected location. The processor is further configured to control a position and orientation of the acoustic transducer relative to the drill bit cutter. The reflective surfaces of the cutter include a cutting surface of the cutter and an interface between the cutter and a substrate that couples the cutter to the drill bit. The ultrasonic transducer may include a single ultrasonic transducer having an adjustable focal length or a first ultrasonic transducer having a first focal length and a second ultrasonic transducer having a second focal length, in various embodiments. Additionally, the ultrasonic transducer may be a single transducer or a phased array transducer. The ultrasonic transducer is configured to scan the cutter using a raster scan pattern. The processor may be further configured to execute an artificial intelligence program to scan the formed image and provide a recommended course of action with respect to the drill bit. The apparatus further includes an orientation device configured to orient the ultrasonic transducer along three substantially orthogonal axes.

While the foregoing disclosure is directed to the certain exemplary embodiments of the disclosure, various modifications will be apparent to those skilled in the art. It is intended that all variations within the scope and spirit of the appended claims be embraced by the foregoing disclosure.

What is claimed is:

1. A method of determining a condition of a cutter coupled to a drill bit, comprising:
disposing the drill bit with a cutter coupled thereto at a selected location;
positioning an ultrasonic transducer relative to the cutter;
activating the ultrasonic transducer to generate an ultrasonic pulse;
obtaining a reflection of the ultrasonic pulse from a reflective surface of the cutter;
forming an image of the cutter coupled to the drill bit using the reflected ultrasonic pulse; and
determining the condition of the cutter from the image.

2. The method of claim 1, wherein disposing the drill bit further comprises submerging the drill bit in an acoustically coupling fluid.

3. The method of claim 1, wherein positioning the acoustic transducer relative to the cutter further comprises using positioning the acoustic transducer using at least one of: (i) a model of the drill bit; and (ii) a detection system for locating the cutter at the selected location.

4. The method of claim 1, wherein positioning the ultrasonic transducer relative to the cutter further comprises controlling a position and orientation of the ultrasonic transducer.

5. The method of claim 1, wherein activating the transducer comprises transmitting ultrasonic waves at a frequency selected to obtain the reflected ultrasonic pulse from at least one of: (i) a cutting surface of the cutter; and (ii) an interface of the cutter and a substrate coupling the cutter to a drill bit body.

6. The method of claim 1, wherein the transducer comprises at least one of: (i) a single ultrasonic transducer having an adjustable focal length; and (ii) a first ultrasonic transducer having a first focal length and a second ultrasonic transducer having a second focal length.

7. The method of claim 1, wherein the ultrasonic transducer is selected from the group consisting of: (i) a single transducer; and (ii) a phased array transducer.

8. The method of claim 1, wherein activating the ultrasonic transducer comprises performing a raster scan.

9. The method of claim 1, further comprising scanning the formed image by an artificial intelligence program to generate a recommended course of action with respect to the drill bit.

10. An apparatus for determining a condition of a cutter on a drill bit, comprising:
a support configured to dispose the drill bit and the cutter at a selected location;
an ultrasonic transducer configured to generate an ultrasonic pulse and obtain a reflection of the generated ultrasonic pulse from a reflective surface of the cutter;
a positioning device configured to position the ultrasonic transducer relative to the cutter; and
a processor configured to form an image of the reflective surface of the cutter using the reflected ultrasonic pulse while the cutter is coupled to the drill bit.

12. The apparatus of claim 11, further comprising a tank containing an acoustically coupling fluid, wherein the selected location is a location within the acoustically coupling fluid.

13. The apparatus of claim 11, wherein the processor is further configured to position the acoustic transducer relative to the cutter further using at least one of: (i) a model of the drill bit; and (ii) a detection system for locating the cutter at the selected location.

14. The apparatus of claim 11, wherein the processor is further configured to control a position and orientation of the acoustic transducer relative to the drill bit cutter.

15. The apparatus of claim 11, wherein the reflective surface of the cutter is at least one of: (i) a cutting surface of the cutter; and (ii) an interface between the cutter and a substrate that couples the cutter to the drill bit.

16. The apparatus of claim 11, wherein the ultrasonic transducer further comprises at least one of: (i) a single ultrasonic transducer having an adjustable focal length; and (ii) a first ultrasonic transducer having a first focal length and a second ultrasonic transducer having a second focal length.

17. The apparatus of claim 11, wherein the ultrasonic transducer is selected from the group consisting of: (i) a single transducer; and (ii) a phased array transducer.

18. The apparatus of claim 11, wherein the ultrasonic transducer is configured to scan the cutter using a raster scan pattern.

19. The apparatus of claim 11, wherein the processor is further configured to execute an artificial intelligence program to scan the formed image and provide a recommended course of action with respect to the drill bit.

20. The apparatus of claim 11, further comprising an orientation device configured to orient the ultrasonic transducer along three substantially orthogonal axes.
